(19) United States
(12) Patent Application Publication
(10) Pub. No.: US 2025/0134134 A1
(43) Pub. Date: May 1, 2025

(54) WHOLE-MUSCLE MEAT ANALOGUES WITH FLUID ACCOMMODATING SPACES AND METHOD OF PRODUCING THE SAME

(71) Applicant: Redefine Meat Ltd., Rehovot (IL)

(72) Inventors: Oded HALEVI, Or Akiva (IL); Daniel DIKOVSKY, Ariel (IL)

(21) Appl. No.: 18/690,844

(22) PCT Filed: Sep. 13, 2022
(86) PCT No.: PCT/IL2022/050989

§ 371 Date: Mar. 11, 2024

(30) Foreign Application Priority Data
Sep. 13, 2021 (IL) 286331

(51) Int. Cl. A23J 3/22; A23L 13/60; A23P 20/20; A23P 20/25; B33Y 10/00; B33Y 80/00

(52) U.S. Cl. CPC A23J 3/227; A23L 13/67; A23P 20/20; B33Y 10/00; B33Y 80/00; A23P 2020/253

(57) ABSTRACT

The present disclosure provide a whole-muscle meat analogue product and method of producing the same, the product comprising (i) a protein mass including protein strands and (ii) a plurality of fluid accommodating spaces within the protein mass, the plurality of fluid accommodating spaces having a length and cross-sectional dimension perpendicular to said length wherein at least a portion of said fluid accommodating spaces are elongated spaces extending between a first end and a second end; wherein the length of the fluid accommodating elongated spaces is at least 2 mm and is at least twice larger than said cross sectional dimension; wherein at least 40% of said elongated spaces have essentially the same nominal direction, one with respect to another, within said whole-muscle meat analogue product; and wherein said fluid in the fluid accommodating spaces is a gas.

### TECHNOLOGICAL FIELD

The present disclosure relates to the food industry and more specifically to the meat alternative industry.

### BACKGROUND ART

References considered to be relevant as background to the presently disclosed subject matter are listed below:
Japanese patent No. JP5025522 B2
International Patent Application Publication No. WO2021032866
US Patent Application Publication No. US2012237661
US Patent Application Publication No. US20190373935
International Patent Application Publication No. WO 20208104
International Patent Application Publication No. WO2020152689
International Patent Application Publication No. WO2021095034
US Patent Application Publication No. US2017035076

Acknowledgement of the above references herein is not to be inferred as meaning that these are in any way relevant to the patentability of the presently disclosed subject matter.

### BACKGROUND

Food technology involves the production of products, processes and services aiming, inter alia, to meet the needs and requirements of consumers as well as that of the fast-growing demographic demands.

Awareness for reducing consumption of animal-originated meat is rising globally, leading to an increased number developed meat-analogues. These analogues are based, inter alia, on plant-proteins and/or cell cultures.

One aspect of such food technologies concentrates on methods for producing porous or foamed food products.

Japanese patent No. JP5025522 describes a method for producing a porous food. The method comprises crushed ice mixed with the pulverized food material, followed by freeze-drying.

WO2021032866 describes a method of producing protein-containing foamed food product; the method comprises introducing gas or gas forming material while extruding protein containing raw material to thereby form a protein containing foamed food product.

US2012237661 describes an impregnated food, wherein a porous solid edible food has been impregnated with a foamed food dough.

US2019/0373935 describes a method of growing a fungal mycelium for an edible food product. In one example, the mycelium is dehydrated, followed by a marination that is composed of sauces and flavorings.

WO20208104 describes a meat analogue comprising a macrostructure of connected sheared fibers oriented substantially parallel to one another and gaps positioned between the sheared fibers.

WO2020152689 describes a meat analogue that comprises a protein-based component and a fat-based component separately distributed within the meat analogue; wherein the meat analogue comprises at least one segment that consists essentially of the protein based component which is chemically distinct from at least one other segment that consists essentially of the fat-based component; and wherein at least one of the following is fulfilled (i) a cubic sample of the meat analogue exhibits an anisotropic physical property and (ii) the meat analogue comprises a non-homogenous distribution of the protein based component and the fat-based component.

WO2021095034 describes a whole muscle meat substitute and method for its production using additive manufacturing techniques.

US2017035076 describes food products having structures, textures, and other properties similar to those of animal meat, and that comprise substantial amounts of cell wall material.

### GENERAL DESCRIPTION

The present disclosure is based on the development of whole-muscle meat analogue products (also referred to, at times, as whole-cut meat analogues or whole-muscle meat cut) that are designed to include, in a controlled manner, voids or channels for holding fluid matter to thereby improve, inter alia, the texture and organoleptic properties of the product, such as its juiciness.

Specifically, it has been found beneficial to produce a whole cut meat product with dedicated gas accommodating channels that are treated before being immersed in a marinade. As a result, the final product was found to resemble more, in terms of texture and mouthfeel, true meat.

Thus, in accordance with a first aspect of the presently disclosed subject matter, there is provided a whole-muscle meat analogue product comprising (i) a protein mass including protein strands and (ii) a plurality of fluid accommodating spaces within the protein mass, at least a portion of the plurality of fluid accommodating spaces having a length and cross-sectional dimension that is perpendicular to said length;
wherein at least a portion of said fluid accommodating spaces are elongated spaces extending between a first end and a second end;
wherein the length of the fluid accommodating spaces is at least 2 mm and is at least twice larger than said cross sectional dimension;
wherein at least 40% of said fluid accommodating spaces have essentially the same nominal direction one with respect to the other within said whole-muscle meat analogue product; and
wherein said fluid in the fluid accommodating spaces is a gas.

In some examples of the presently disclosed subject matter, the gas is selected from the group consisting of oxygen, air, nitrogen gas, carbon dioxide. In some examples of the presently disclosed subject matter, the gas is air.

When filled with gas (e.g. air), the whole-muscle meat analogue product can be considered, at times, as an intermediate product, suitable for marination at a later stage, e.g. within a manufacturer's plant, by a butcher (at a butcher shop or department) or by the end consumer.

Also provided, in accordance with a second aspect of the presently disclosed subject matter, a method of producing a whole-muscle meat analogue product, the method comprising:
disposing two or more layers of protein strands comprising protein mass one on top of another to form a multi-layer protein mass;
applying onto the multi-layer protein mass, controlled conditions that cause the arrangement of a plurality of fluid accommodating spaces within the protein mass, the plurality of fluid accommodating spaces being defined by a length and a cross sectional dimension perpendicular to said length and the conditions are selected such that
(i) at least a portion of the fluid accommodating spaces extending between a first end and a second end;
(ii) the length of the fluid accommodating spaces is at least 2 mm, and that is at least twice larger than the cross-sectional dimension;
(iii) at least a portion (e.g. at least 40%) of the fluid accommodating spaces have a same nominal direction, one with respect to another, within said whole-muscle meat analogue product;
wherein the fluid in the fluid accommodating spaces is gas, and
wherein said fluid accommodating spaces are suitable for accommodating liquid.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a schematic illustration of an alternative whole meat cut (e.g. steak) sample, defined by a Cartesian coordinate system.

FIG. 2 is a graph showing the degree of deviation of the longitudinal direction of each fluid accommodating space from the longitudinal direction of the protein strands; where the majority of the fluid accommodating spaces are oriented within 5 degrees from the z axis, i.e. from the longitudinal direction of the strands.

FIGS. 3 is a block diagram of a methodology for determining the volume percentage of the fluid accommodating space within the 3D matrix, in accordance with some examples of the first aspect of the presently disclosed subject matter.

FIGS. 4A-4B are images of two a steak analogue samples, cut along the YZ plane or XZ plane as shown in FIG. 1 (i.e. parallel to the direction of the protein stands), a first sample produced with intentionally introduced elongated spaces, some of which being circled (FIG. 4A) and another sample produced without elongated spaces (FIG. 4B); both images were taken after the samples were immersed in colored water marinade; the elongated spaces were formed with a needles-bed, as described in the non-limiting Example 1A).

FIGS. 5A-5C are three different non-limiting Examples of a 3D printing model showing a cross section of the printed product and illustrating the x-axis pitch between printed strands (marked as “x”) of 2.5 (FIG. 5A), 3.8 (FIG. 5B) and 5 mm (FIG. 5C).

FIGS. 6A-6B are images of two steak analogue samples cut along the XY plane in FIG. 1, a first sample including designed and controlled gas-filled elongated spaces introduced therethrough, the elongated spaces (FIG. 6A) and another sample produced without elongated spaces (FIG. 6B); the elongated spaces were formed during 3D-printing, as described in the non-limiting Example 1B.

FIG. 7 is a block diagram of the methodology of determining the orientation of elongated spaces within a whole-muscle meat analogue product, in accordance with some examples of the present disclosure.

FIG. 8 is a schematic illustration of an immediate environment of a voxel (marked as a black cube) within the 3D matrix, the voxel being surrounded by 26 voxels (shown as hollow cubes).

FIGS. 9A-9B provided is a micro-CT compiled 3D image (FIG. 9A), of a steak cut “900” from an exemplary whole-muscle meat analogue product disclosed herein along the XY plane, the images showing elongated spaces (“910”) and amorphous spaces (“920”), one of the CT image slices is being magnified in FIG. 9B to better illustrate the larger spaces that represent the fluid accommodating spaces and the smaller spaces that represent the amorphous spaces.

FIG. 10 is a block diagram of the methodology of determining the percentage of the fluid accommodating elongated voids/channels/spaces that are exposed to the outer environment through the edges of the sample.

### DETAILED DESCRIPTION

When dealing with whole-muscle meat analogues, the sensory experience is greatly dependent on the product's chemical and physical structure(s) and properties, typically, due to the anisotropic structure of the whole-muscle meat product.

In addition, true meat (whole-muscle or whole-cut or whole-muscle meat cut) undergoes a process of rigor mortis where water migrates from the cells outward, towards the extracellular space, due to shrinking of the muscle cells. The migrated water is considered “free water”, which forms the drip-loss phenomena during storage, cooking loss during cooking, and is a main contributor to the juiciness that is sensed during oral processing of the meat. In this connection, juiciness may be defined as the organoleptic property dictated by the amount of “free water” released from a food product due to the few first bites and/or chews during oral processing of the food.

The present disclosure aims, inter alia, at imitating the result of the rigor mortis natural process and to thereby provide the structural conditions that allow the harboring of fluids, i.e. “free water”, that can be released upon external stimulation, such as temperature, pressure, shear forces etc.

It has been found, and now disclosed herein, that it is possible to significantly improve the organoleptic properties of the meat analogue product if prior to impregnating with liquids, the product including the protein mass and the gas accommodating spaces, is gently heat treated (e.g. Sous-vide or combi-steamer) and only thereafter, the majority of the gas is replaced with liquid.

Without being bound by theory, it is believed that the gentle heat treatment causes at least partial denaturation of the protein mass, including, inter alia, at the walls of the fluid accommodating spaces. This is considered to improve the withholding/retaining of the free water within the fluid accommodating spaces (the free water coming from marination etc), and thereby to improve the juiciness and other organoleptic properties of the final (ready for consumption) product.

Accordingly, the first aspect of the presently disclosed subject matter provides a whole-muscle meat analogue product comprising a protein mass in a form of protein strands and within the protein mass, a plurality of fluid accommodating spaces that accommodate fluid or are configured to accommodate liquid matter, the fluid accommodating spaces being defined by a length (i.e. longitudinal dimension) and a cross section being perpendicular to the longitudinal direction of the fluid accommodating space (i.e. thickness);
wherein at least a portion of said fluid accommodating spaces are elongated spaces extending between a first end and second end;
wherein the length of the fluid accommodating spaces is at least about 2 mm and is at least twice larger than said cross sectional dimension;
wherein a significant portion (e.g. at least about 40%, or at least about 50%) of the fluid accommodating spaces have a nominal direction which is essentially aligned one with respect to the other, and in some examples, essentially aligned with the nominal direction of the protein strands within said whole-muscle meat analogue product; and
wherein said fluid in the fluid accommodating spaces is a gas.

The product, having gas (e.g. air) occupying the fluid accommodating spaces, is suitable for marination, whereby at least a portion of the gas is replaced with the marinade liquid.

When referring to replacement of gas with liquid (by marination or by other means), it is to be understood that the replacement of gas by the liquid can be such gas is replaced in a specific elongated space along the entire length of the space (i.e. gas is completely replaced with liquid in the particular elongated space), along a portion of the space (i.e. some percent of the gas is still retained in the elongated space), and/or some elongated spaces are not replaced with liquid at all (i.e. retain the gas content as before immersion in the liquid).

It has been concluded that the product according to the presently disclosed subject matter includes at least partially denaturated protein in the protein mass that contributes to the organoleptic properties of the eventual, marinated product.

To allow effective introduction of liquid into the fluid accommodating spaces it is preferable that at least portions of the spaces are externally exposed to the surrounding of the product. Thus, in some examples, the first end and/or the second end of at least a portion of the fluid accommodating spaces are open ended to an external surface of the whole-muscle meat analogue product.

In the context of the present disclosure, when referring to “external surface” of the whole-muscle meat analogue product or a sample thereof, it is to be understood to also encompass the area in proximity to the surface or in other words, within the surface's edge limit. In some examples, the edge limit is defined to encompass up to a distance of 0.25 mm from the external surface of the product, when the distance is measured perpendicular to the surface.

In some other examples, the first end and/or the second end of at least a portion of the fluid accommodating spaces are exposed to an external surface of the whole-muscle meat analogue product.

The protein mass comprises protein strands. In the context of the presently disclosed subject matter, the term protein strands within the whole-muscle meat analogue product is to be understood to refer to the presence of protein matter in a filamentous form/shape within the protein mass, wherein the filamentous form is defined as one having a length and a cross-sectional dimension, the length being at least twice larger than the cross section of the strand, and wherein the filamentous matter can be visualized without the need or aid of any magnifying means (i.e. can be identified by eye vision only). Without being bound thereto, the cross-sectional dimension of a protein strands can be as low as several micrometers, or as low as tens, or hundreds of micrometers (e.g. as low as 0.1 mm). In some examples, the protein strands obtain their shape by flowing through a nozzle of defined dimensions, such as nozzles used in additive manufacturing techniques.

Further, in the context of the presently disclosed subject matter, the term whole-muscle meat analogue product is to be understood to encompass plant-based alternatives/analogues to a variety of animal-originated meat, including but not limited thereto red meat (e.g. beef, horse meat, mutton, venison, boar, hare) as well as white meat (e.g. rabbit, veal, lamb, pork). In some examples, the meat is red meat. In some other examples, the meat is pork meat. In some examples, the meat analogue does not include poultry. In some other examples the meat analogue does not include fish.

In some examples, the whole-muscle meat analogue product of the presently disclosed subject matter, is in a form of a whole slab.

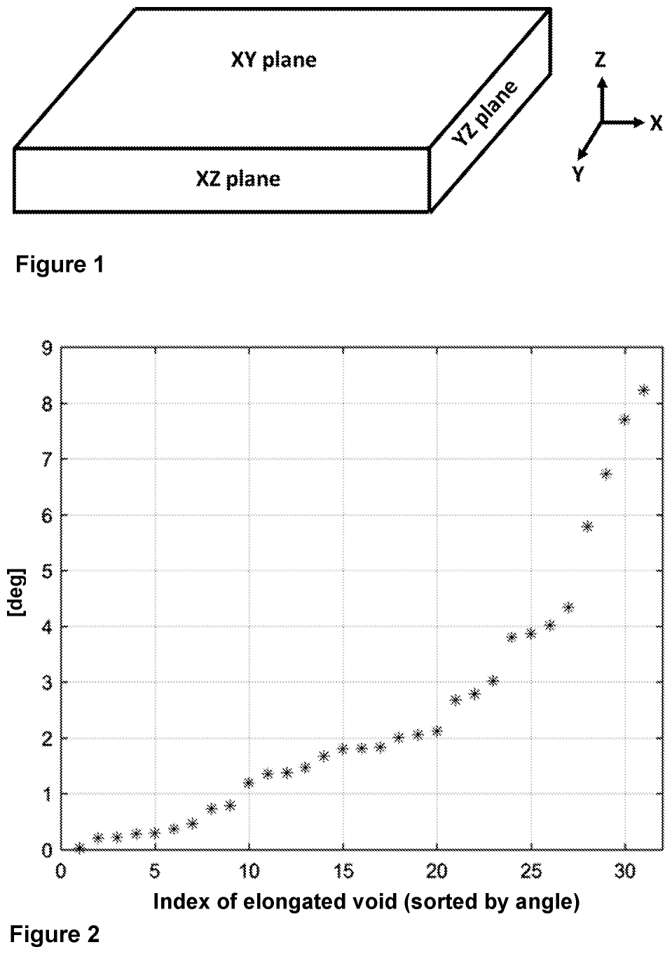

In some other examples of the presently disclosed subject matter, the whole-muscle meat analogue product is in a form of a steak. In this example, the presently disclosed steak product can be defined by having a length and width that define together a horizontal plane of the steak (XY plane in FIG. 1), and a cross sectional dimension that is perpendicular to the horizontal plane (FIG. 1). In the context of the present disclosure, the fluid accommodating spaces are parallel to the direction of the thickness (z direction in FIG. 1), i.e. perpendicular to the horizontal plane of the steak.

The protein mass comprises fluid accommodating spaces. In the context of the presently disclosed subject matter, when referring to “fluid accommodating space” (at times, referred to herein as the “elongated space” or the “elongated fluid accommodated space”) it is to be understood to encompass any volume within the edible protein mass that forms a spatial discontinuity of the protein mass. The fluid accommodating space is a void that withholds or can withhold fluids such as gas without collapsing and/or liquid (e.g. following impregnation of the protein mass in such liquid). The void may be in a form of “closed void” or “an essentially closed void”, meaning being completely or almost completely enveloped by the solid protein mass, or “open void”, in a form of a channel with fluid communication with other voids within the protein mass, and/or with the outer environment of the protein mass.

The protein mass can be of a variety of sources that are acceptable and safe for human use or consumption.

In some examples of the presently disclosed subject matter, to constitute a meat alternative, the whole-muscle meat analogue product comprises non-animal derived proteins.

In some examples of the presently disclosed subject matter, the protein is plant derived (e.g. isolate or concentrate) or comprises plant derived edible protein(s) and/or peptide(s) and/or amino acids.

The protein material can include one or more proteins in combination with other non-protein material, e.g. fat. Yet, even if fat is included, the protein constitutes the component with the highest percentage within the protein mass as further discussed below.

In some examples of the presently disclosed subject matter, the plant source for the protein can be, without being limited thereto, any one or combination of soy, wheat, legume (pulses, beans, peas, lentils, nuts), plant seeds and grains (e.g. sunflower, canola, rice), stem or tuber protein (e.g. potato protein), rapeseed and corn.

In some examples of the presently disclosed subject matter, the protein is derived from legume. Specific, yet non-limiting examples of legume/bean proteins include, soy protein, pea protein, chickpea protein, lupine protein, mung-bean protein, kidney bean protein, black bean protein, alfalfa protein.

In some examples of the presently disclosed subject matter, proteins suitable for meat analogues as disclosed herein are beta-gonglycinin, glycinin, vicilin, legumin, albumins, globulins, glutelins, gluten, gliadins, glutenins, mycoproteins.

In some examples of the presently disclosed subject matter, the protein can be derived from sources other than plants, such as algae, fungi (e.g. yeast), bacteria and microorganisms in general.

In some examples of the presently disclosed subject matter, the protein material is of non-mammal source.

In yet some other example of the presently disclosed subject matter, part of the protein material can contain animal derived components, e.g. beef muscle, chicken muscle fibers, insect based protein powders, etc., or achieved by means of cell culture, even if the source of the cell is from animal.

In some examples of the presently disclosed subject matter, the protein mass used herein is one that lacks mammal-or animal-derived components (excluding components obtained from cell culture).

The protein mass can be in the form of a pure protein, a protein isolate, protein concentrate, protein flour, texturized protein such as texturized vegetable protein (TVP).

In some examples of the presently disclosed subject matter, the protein mass comprises textured vegetable protein (TVP). TVP is known in the art to be used as a meat extender or vegetarian meat and is usually created by extruding protein isolates or concentrates using high shear, pressure and heat, from vegetable sources such as wheat, pea and others. TVP is commercially available in different sizes from large chunks to small flakes.

In some examples of the presently disclosed subject matter, when comprising TVP, the protein mass includes up to 80% v/v TVP, i.e. the protein mass is not a pure TVP.

In the context of the presently disclosed subject matter, TVP is used to denote both dry form of textured vegetable protein (sometimes regarded to as expanded TVP), as well as high moisture form, known in the art as the outcome of high moisture extrusion (HME) or high moisture extrusion cooking (HMEC) or similarly. TVP may also denote any “intermediate” form of textured vegetable protein, in which the moisture level in the TVP and/or the degree of expansion of the TVP is intermediate between those typically found in dry (expanded) form and HME (C) form.

In some examples of the presently disclosed subject matter, the protein mass comprises soy protein.

In some examples of the presently disclosed subject matter, the protein mass comprises pea protein.

In some examples of the presently disclosed subject matter, the protein mass comprises chickpea protein.

In some examples of the presently disclosed subject matter, the protein mass comprises gluten, which is known to form fibrous structure in its native form, by plain hydration.

Without being bound by theory, soy-based, pea-based, chickpea-based and/or gluten-based fibers may be aligned into a certain direction by pulling or pushing through a printing nozzle.

The protein mass can include a single type of protein or a combination of proteins.

As noted above, the protein mass can include substances other than protein material per se. In some examples of the presently disclosed subject matter, the protein mass comprises at least 20% protein, and yet in some preferred examples, the protein mass comprises at least 25% protein, at least 30% protein, at least 35%, at least 40%, at least 45%, at least 50%, at least 55%, at least 60%, at least 70% or even at least 80% protein per se.

In some examples of the presently disclosed subject matter, the protein mass is free of lipids (e.g. fat and/or oil).

In some other examples of the presently disclosed subject matter, the protein mass contains lipids, e.g. to modulate the rheological properties, e.g. flexibility of the protein strands and eventual alternative meat product and/or to improve organoleptic properties.

The protein mass can include edible additives, such as, without being limited thereto, fibers originating from either protein and/or carbohydrate origin, including without limitation starches and dietary nutritional fibers (and other forms of cellulose-based fibers, e.g. fibers originating from citrus source); colorants (e.g. annatto extract, caramel, elderberry extract, lycopene, paprika, turmeric, spirulina extract, carotenoids, chlorophyllin, anthocyanins, and betanin), emulsifiers, acidulants (e.g. vinegar, lactic acid, citric acid, tartaric acid malic acid, and fumaric acid), flavoring agents or flavoring enhancing agents (e.g. monosodium glutamate), antioxidants (e.g. ascorbic acid, rosemary extract, aspalathin, quercetin, and various tocopherols), dietary fortifying agents (e.g. amino acids, vitamins and minerals), preservatives, stabilizers, sweeteners, gelling agents, and thickeners.

In some examples of the presently disclosed subject matter, the protein mass comprises essentially axially aligned protein strands. The alignment of the protein strands within the protein mass can be obtained by various techniques. For example, by applying constant mechanical forces in a certain direction on a flowing protein mass either by continuous pushing (e.g. as done during extrusion), continuous pulling (e.g. as done in spinning) and shearing (e.g. as done in a shear Couette cell).

The alignment techniques may utilize thermal effects (e.g. heating or cooling), chemical and/or biological agents (e.g. coagulation, enzymes) etc., for enhancing the anisotropic character of the resulting strands.

In some examples of the presently disclosed subject matter, the essential alignment of the protein strands within the protein mass is obtained by extrusion, such as hot extrusion or cold extrusion. Accordingly, the protein mass comprises protein extrudate.

In some other examples of the presently disclosed subject matter, the essential alignment of the protein is obtained by spinning, e.g. carried out using an electrospinning device. There are different approaches in spinning of proteins so as to texturize them, including, without being limited thereto, an enzymatic approach (typically to yield a gel like structure), a dehydration approach (typically to rigidify the protein material); a temperature approach (to affect flowability/solubility of the protein material); an anti-diluent approach (typically referred to as a wet spinning); pH approach (typically also to affect solubility of the protein mass, for example, chitosan which is more soluble at weak acidic conditions).

In some examples of the presently disclosed subject matter, in order to facilitate the formation of essentially aligned strands, the protein mass can also comprise one or more polysaccharides. Without being limited thereto, these include polysaccharides that are water soluble or polymers that are soluble at specific pH. Such polymers include, without being limited thereto, Guam gum, Xanthan gum, k-Carrageenan, chitosan, cellulose, starch and lignin.

In some examples of the presently disclosed subject matter, elongated fluid accommodating spaces are essentially aligned (i.e. have essentially the same nominal direction) with the direction of the protein strands within the protein mass.

In the context of the presently disclosed subject matter, the terms “essentially” or “significantly” are to be understood to also include some level of deviation (e.g. 1%, 2%, 3%, 10% or even up to about 20%) from the defined parameter.

The term “nominal direction” as used in the context of the presently disclosed subject matter, refers to a direction where significantly more than about 40%, at times more than 50% of the protein strands and/or the elongated fluid accommodating spaces within the product have a deviation of less than about ±15 degrees, at times less than about ±10 degrees; at times, less than about ±5 degrees (FIG. 2), when the protein strands or the spaces are viewed from any direction perpendicular to their direction. The term “nominal direction” may also refer to the average of the strands' direction or to the elongated fluid accommodating spaces' direction, as found using high magnification imaging.

In some examples of the presently disclosed subject matter, the nominal direction of the fluid accommodating spaces within a segment of product is generally parallel to the direction of the protein strands within the product for at least about 80%, preferably 95% and preferably 99% of the protein strands.

In the context of the presently disclosed subject matter, when referring to fluid accommodating spaces it is to be understood to encompass voids (either “closed void” or “open void”) that have an elongated shape, i.e. with one dimension being at least twice longer/larger than at least one other dimension of the fluid accommodating spaces within the protein mass. The elongated fluid accommodating spaces can be viewed by conventional magnification tools as a channel within the protein mass, this being somewhat different from other fluid accommodating voids within the protein mass that do not fall within the definition of “elongated spaces”.

In some examples of the presently disclosed subject matter, the elongated spaces have a length of at least 2 mm; at times, of at least 3 mm; at times, of at least 4 mm; at times, of at least 5 mm; at times, of at least 6 mm at times, of at least 7 mm at times, of at least 8 mm at times, of at least 9 mm at times, of at least 10 mm at times, of at least 15 mm; at times, of at least 20 mm at times, of at least 25 mm at times, of at least 30 mm; at times, of at least 35 mm at times, of at least 40 mm at times, of at least 45 mm.

In some examples of the presently disclosed subject matter, at least a portion (e.g. at least 40%) of the elongated spaces have a length that is essentially equivalent to at least about ⅛, at times, about ¼; at times, about ½, at times, about ⅔, at times about ⅗ of the length along one dimension of the meat analogue. Without being bound by theory, the introduction of dedicated and elongated channels aligned along at least ½ the length of one dimension of the product will provide a superior product (e.g. in terms of organoleptic properties after marination) over a product produced from the same protein mass, and same heat treatment prior to marination, yet, without actively forming the dedicated elongated channels.

The elongated fluid accommodating spaces can be defined by their cross-sectional dimension (also referred to at times by the term thickness) being perpendicular to the longitudinal direction (length) of the elongated space. In some examples of the presently disclosed subject matter, the thickness (cross sectional dimension) of the elongated spaces is of at least 20 μm; at times, at least 50 μm; at times, at least 70 μm at times, at least 100 μm at times, at least 120 μm at times, at least 150 μm at times, at least 1700 μm at times, at least 200 μm at times, at least 220 μm at times, at least 250 μm at times, at least 270 μm at times, at least 300 μm at times, at least 320 μm at times, at least 350 μm at times, at least 370 μm at times, at least 400 μm at times, at least 420 μm at times, at least 450 μm at times, at least 470 μm at times, at least 500 μm. In some examples, the elongated spaces have a cross sectional dimension of between 20 μm and 10 mm (as long as the cross section is at most half the length of the elongated spaces).

In some examples of the presently disclosed subject matter, the elongated spaces have a rod shape, namely, are essentially straight channels, with the majority (e.g. at least about 50%, or at least about 60% or at least about 70% or >80%) of the channel being essentially parallel to the longitudinal direction of the protein strands.

In some examples of the presently disclosed subject matter, the protein mass includes fluid accommodating spaces that are amorphous in shape, i.e. there is no one dimension that is at least twice larger than one other dimension in the mass. In other words, the protein mass can include also spaces that are a priori different from the elongated spaces as defined herein.

In some examples of the presently disclosed subject matter, the amorphous spaces are formed by the incorporation of gas-generating compounds such as, without being limited thereto, sodium bicarbonate, sodium carbonate, potassium carbonate. These spaces are defined by a cross sectional dimension of at least 1 μm. the amorphous spaces can be closed voids or open voids, as defined hereinabove.

In some examples of the presently disclosed subject matter, the meat analogue product comprises two populations of fluid accommodating spaces as defined herein, at least one being elongated spaces and at least one other being amorphous in shape as defined here.

The elongated fluid accommodating spaces can have an essentially identical shape and/or dimensions or may be different. In some examples, at least the elongated spaces have essentially the same cross-sectional dimension.

In some examples of the presently disclosed subject matter, at least the elongated fluid accommodating spaces have essentially the same cross-sectional dimension throughout the protein mass (the product).

The fluid accommodating spaces are distributed within the protein mass. The distribution can be defined by the distance between a first fluid accommodating space and its neighboring fluid accommodating space. For example, a fluid accommodating space may be defined by an imaginary center and its distance from its neighboring fluid accommodating spaces can be defined by the distance between their respective imaginary centers.

In some examples of the presently disclosed subject matter, the distance between two neighboring fluid accommodating spaces is of at least 0.5 mm; at times, of at least 0.6 mm; at times, of at least 0.7 mm; at times, of at least 0.8 mm; at times, of at least 0.9 mm; at times, of at least 1.0 mm; at times, of at least 1.1 mm; at times, of at least 1.2 mm; at times, of at least 1.3 mm; at times, of at least 1.4 mm; at times, of at least 1.5 mm; at times, of at least 1.6 mm; at times, of at least 1.7 mm; at times, of at least 1.8 mm; at times, of at least 1.9 mm; at times, of at least 2.0 mm.

In some examples of the presently disclosed subject matter, the distance between the said imaginary centers is at most 10 mm. In some examples, the distance is at most 9 mm; at times, at most 8 mm; at times at most 7 mm; at times, at most 6 mm; at times, at most 5 mm; at times, at most 4 mm; at times, at most 3 mm; at times, at most 2 mm.

In some examples of the presently disclosed subject matter, the distance between the said imaginary centers is between about 0.5 mm and 10 mm, or any range between 0.5 mm and 10 mm, each such possible range constituting a separate and independent example of the present disclosure.

The liquid accommodating spaces can also be defined by the volume they occupy or weight they constitute out of the total volume/weight of the whole-muscle meat analogue product.

In some examples of the presently disclosed subject matter, the fluid accommodating spaces occupy/constitute or are designed to occupy/constitute a volume of between 1% and 20% out of the total volume of the product.

In some other examples, the fluid accommodating spaces occupy/constitute or are configured to accommodate an amount of fluid of between 10 wt % to 40 wt % out of the total weight of the product.

In some other examples, the fluid accommodating spaces provide a relatively high surface area for absorption of liquid by the protein mass and withholding/retaining liquid in the elongated voids/channels, e.g. after immersion in a marinade. The total liquid absorbed and occupied constitute between 10 wt % and 50 wt %, at times between 15 wt % and 40 wt %, of the total weight of the product, which is not necessarily retained only within the fluid accommodating spaces.

Without being bound thereto, it is believed that the presence of the fluid accommodating spaces and the treatment applied to the product prior to the active introduction of liquid (e.g. by the impregnation in a marinade) allows for a higher liquid absorbance and for a high level of free water remaining within the elongated spaces as compared to a similar product having the same protein mass, however, is absent of the elongated fluid accommodating spaces as defined herein.

The volume % or weight % of the fluid accommodating spaces vis-a-vis the whole product can be determined by any of the following procedures:

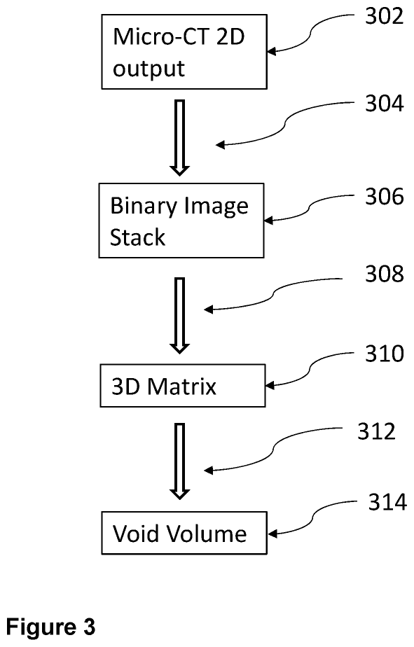

Volume determination—the volume of the fluid accommodating spaces can be determined by measuring the volume of the product before and after applying pressure on the product until maximum (without disrupting the integrity of the product) and measuring the difference in volume. Alternatively, the volume can be determined using micro-CT, Ultrasound (US) as well as other imaging technologies known in the art. Without being limited thereto, the volume may be determined using the following micro-CT image analysis procedure, which is also illustrated in FIG. 3. Specifically, utilizing image analysis tools, such as but not limited to MATLAB software, the 2D cross section image files of the scanned sample (Micro-CT 2D output as image stack, 302) are transformed, for instance by thresholding by grayscale population (304) into binary images (i.e. comprising only black and white pixels, 306) preferably according to the following threshold: half the grey level of the most probable non-zero and non-saturated grey level. The 2D images are then compiled (by constant grid compilation, 308) to form a binary 3D matrix (310) (e.g. comprising only black and white voxels). To calculate the total volume percentage of the voids, the sum of the void-representing voxels that are located within the sample is divided by the total number of the voxels that compose the 3D matrix (312) resulting in determination of void volume percentage (314). Needless to say, other techniques for measuring volumes can also be used, as appreciated by those versed in the art.

Weight % determination-the weight of the fluid that accommodates the fluid accommodating spaces can be determined by measuring the weight of the product before and after applying pressure on the product until all fluid is removed (without disrupting the integrity of the product) and measuring the difference in weight.

The whole-muscle meat analogue product can be produced by additive manufacturing techniques. According to a second aspect of the presently disclosed subject matter, there is thus provided a method of producing a whole-muscle meat analogue product. The presently disclosed method comprises at least the following:
disposing two or more layers of protein mass comprising protein strands one on top of another to form a multi-layer protein mass;
applying onto the multi-layer protein mass, controlled conditions that cause the arrangement of a plurality of elongated fluid accommodating spaces within the protein mass, the plurality of fluid accommodating spaces being defined by a length and cross sectional dimension and the conditions are selected such that (i) at least a portion of the fluid accommodating spaces are elongated spaces extending between a first end and a second end; (ii) the length of the elongated spaces is at least 2 mm, and that is at least twice larger than the cross sectional dimension; (iii) at least a portion (e.g. at least 40%) of the elongated spaces have a nominal direction, i.e. are essentially aligned one with respect to another within said meat analogue product; wherein the fluid in the fluid accommodating spaces is gas, and wherein said fluid accommodating spaces are suitable for accommodating liquid (e.g. once at least a portion of the whole muscle meat analogue product is immersed in said liquid).

In the context of the presently disclosed method, when referring to “disposing” it is to be understood to encompass any technique that allows the placement of strands of the protein mass onto a displacement bed, forming one layer of the disposed strands on top of another layer of the disposed mass until the entire product is manufactured. The protein mass can be disposed in fluid, semi-fluid, or semi-solid form. In some examples of the presently disclosed subject matter, the disposing is of strands in a defined arrangement according to a computer-generated 3D design file.

In some examples of the presently disclosed subject matter, the term “disposing” can also be used with respect to the application of other components of the product, such as additives or materials other than the protein strands, such as the sacrificial material described hereinbelow. In such examples, it is to be appreciated that also powder (solid) matter can be disposed.

In some examples of the presently disclosed subject matter, the disposing does not include the introduction of aqueous based liquid matter other than the aqueous liquid forming part of the protein mass.

In some examples of the presently disclosed subject matter, the disposing is in accordance with conventional additive manufacturing techniques, such as 3D printing techniques.

In some examples of the presently disclosed subject matter, the disposing is done by extrusion.

In some examples of the presently disclosed subject matter, the disposing of the protein strands is done/performed under controlled conditions.

In some examples of the presently disclosed subject matter, the disposing is in a manner providing essential alignment between the protein strands.

In some examples of the presently disclosed subject matter, the disposing is in a manner providing essential alignment between a portion of the protein strands and the elongated spaces.

In some examples of the presently disclosed subject matter, the disposing is such that at least a portion of the first end and/or the second end of the elongated spaces are at least partially exposed at an external surface of the meat analogue product.

When referring to “controlled conditions” it is to be understood as referring, inter alia, to the disposition rate, disposition temperature, disposition direction, disposition spacing/distances, disposition humidity/atmosphere, etc.

In some examples of the presently disclosed subject matter, at least a portion of the protein strands are disposed with controlled and pre-defined distances therebetween. The controlled distances between the disposed strands form the herein disclosed elongated fluid accommodating spaces. As such, the dimensions and the arrangement/positionings of the spaces between the elongated fluid accommodating spaces are dictated by the distances between the disposed protein strands.

In some examples of the presently disclosed subject matter, the fluid accommodating spaces are formed by disposing a sacrificial material in a form of intermediate strands side by side with at least a portion of the protein strands, i.e. the disposed strands of the sacrificial material neighbor protein strands. As such, some protein strands are juxtaposed with some sacrificial material containing-intermediate strands, while preferably each intermediate strand is surrounded by protein strands (i.e. two intermediate strands will not be placed side by side).

Once the multi-layer protein mass is formed, the sacrificial material is removed, as will be described later, thereby forming the plurality of elongated fluid accommodating spaces.

The sacrificial material forming the intermediate strands can be any material that can be shaped into the desired shape of the elongated spaces within the protein mass, and upon need, be removed.

In some examples, the sacrificial material is placed during the protein deposition step.

In some examples, removal of the sacrificial material is done by chemical and/or physical processes that enable any one of (i) phase transition of the sacrificial material, such as solid to liquid or liquid to gas or solid to gas, (ii) dissolution in a liquid media such as water and/or oils, and/or (iii) reaction with other compounds that will enable its removal from the mass protein.

In some examples of the presently disclosed subject matter, the removal of the sacrificial material can be done by exposing the product to any one or combination of humidity, heat, vibrations, pH-controlled environment, vacuum.

For example, removal of the sacrificial material can be done by increasing the solubility of a sacrificial material in water, e.g. by varying the pH and/or dissolving the sacrificial material by raising the water content and/or increasing the solubility of the material by introducing kinetic energy into the system in the form of heat and/or vibrations. Another example can involve melting of a sacrificial material or inducing a sol-gel transition by increasing of temperature. Once the sacrificial material is in the form of liquid, it can be drained out of the protein mass, leaving the desired spaces.

Another example for removal of the sacrificial material, in accordance with the presently disclosed subject matter, can be to induce a phase-change of the sacrificial material into gas, which in turn is evacuated from the protein mass. For example, sublimation of ice under vacuum and low temperature.

In some examples of the presently disclosed subject matter, the sacrificial material is a polysaccharide or combination of temperature sensitive/affected polysaccharides and thus can be controllably removed by controlling the temperature of the whole-muscle meat analogue product (thereby liquidizing the polysaccharide). A non-limiting list of temperature affected are Agar-Agar and/or guar gum. The polysaccharides can be deposited in various configurations such as powder or gel, and later can be liquidized by dissolving in water or melting at higher temperatures. The liquidized polysaccharides can then be removed by dripping out of the protein mass.

Further, for example, the sacrificial material can be a salt or combination of salts that are removed by dissolution. For example, deposition of NaCl, CaCl₂, and/or KCl and in due course, removal by soaking in water, which leads to the dissolution of the salt.

In some examples of the presently disclosed subject matter, the method comprises compressing the multi-layer protein mass against the sacrificial material containing intermediate strands before the sacrificial material is removed.

In some examples of the presently disclosed subject matter, the elongated fluid accommodating spaces are formed by applying mechanical forces onto the multi-layer protein mass that result in the formation of said plurality of spaces.

In some examples of the presently disclosed subject matter, the mechanical forces for forming the elongated fluid accommodating spaces comprise puncturing the protein mass in a controlled and pre-designed manner. For example, the mechanical puncturing is by using a needle bed, spike bed, drilling means, etc.

After the elongated fluid accommodating spaces are formed the multi-layer protein mass can be subjected to one or more additional manufacturing steps.

In some examples of the presently disclosed subject matter, an additional manufacturing step comprises thermal treatment of the multi-layer protein mass including the fluid accommodating spaces, while the fluid is gas. Thermal treatment may include, without being limited thereto, Sous-vide at about 75° C. or combi-steamer at about 99° C. The range of temperatures may be in the range of 50-100° C.

After the thermal treatment the product can be packed and stored, or it can be subjected to additional manufacturing steps to provide, a ready for consumption product.

In some examples of the presently disclosed subject matter, an additional manufacturing step comprises introducing into the plurality of open spaces a liquid. The introduction of liquid can be by means of soaking or immersing or otherwise marinating the multi-layer protein mass within the liquid. To this end, the fluid accommodating spaces are suitable for accommodating liquid once at least a portion of the whole muscle meat analogue product is immersed in said liquid.

In some examples, the liquid is a water containing liquid. The water containing liquid can be an aqueous solution including edible additives such as flavors, colorants, amino acids, hydrocarbons, fatty acids, salts, pH-regulators, vitamins, etc.

In some examples, the liquid is an emulsion, such as oil in water emulsion, water in oil emulsion, double emulsion, etc., having additives in the oil phase and/or the aqueous phase, such as flavors, colorants, amino acids, hydrocarbons, fatty acids, salts, pH-regulators, vitamins, emulsifiers, etc. The oil of the emulsion may be any edible oil such as sunflower oil, rapeseed oil, olive oil etc.

In some examples, the liquid is a marinade, such as those known in the art.

In some other examples, the liquid is a blood replica, i.e. a composition comprising flavors and colorants providing the multi-layer protein mass with a bloody appearance and flavor.

The presence of liquid in the fluid accommodating spaces, and particularly elongated spaces can be determined post product manufacturing, inter alia, by 3D imaging techniques such as micro-computed tomography (micro-CT), that utilizes X-rays to see inside an object, slice by slice. A non-limiting example of determining presence of elongated spaces within a product according to the present disclosure is provided in Example 2. Alternatively, the fluid accommodating spaces can be detected and analyzed using magnetic resonance imaging (MRI) as well as by using ultrasound (US). This can be performed on the gas filled as well as on an eventual liquid filled product.

As used herein, the forms “a”, “an” and “the” include singular as well as plural references unless the context clearly dictates otherwise. For example, the term “a protein” includes one or more types of proteins, e.g. in the protein mass.

Further, as used herein, the term “comprising” is intended to mean that the composition include the recited components, e.g. the protein mass and the fluid accomodating spaces, but not excluding other elements, such as lipids, salts, water. The term “consisting essentially of” is used to define products which include the recited elements but exclude other elements that may have an essential significance on the quality of the whole-muscle meat analogue product. “Consisting of” shall thus mean excluding more than trace elements of other elements. Embodiments defined by each of these transition terms are within the scope of this invention.

Further, all numerical values, e.g. when referring the amounts or ranges of the elements constituting the whole-muscle meat analogue product, are approximations which are varied (+) or (−) by up to 20%, at-muscle times by up to 10% of from the stated values. It is to be understood, even if not always explicitly stated that all numerical designations are preceded by the term “about”.

The invention will now be exemplified in the following description of experiments that were carried out in accordance with the invention. It is to be understood that these examples are intended to be in the nature of illustration rather than of limitation. Obviously, many modifications and variations of these examples are possible in light of the above teaching. It is therefore, to be understood that within the scope of the appended claims, the invention may be practiced otherwise, in a myriad of possible ways, than as specifically described hereinbelow.

### DETAILED DESCRIPTION OF NON-LIMITING EXAMPLES

Generally, a whole-muscle meat analogue product may be produced by various manufacturing methods among those are additive manufacturing techniques and in particular using a 3D printer that prints stacked layers of organized collection of protein strands.

### Example 1—Preparation of Whole-Muscle Meat Analogue Products

The following non-limiting examples provide three different alternative procedures for preparing the whole-muscle meat analogue product disclosed herein.

### Example 1A—Producing Whole-Muscle Meat Analogue Product using a Needle Bed

In accordance with this non-limiting example, the orientationally defined open spaces are formed by mechanical punching the whole-muscle meat analogue product either upon completion of production or during stages of production (e.g. in additive manufacturing). The mechanical puncturing process is achieved using spikes or needles.

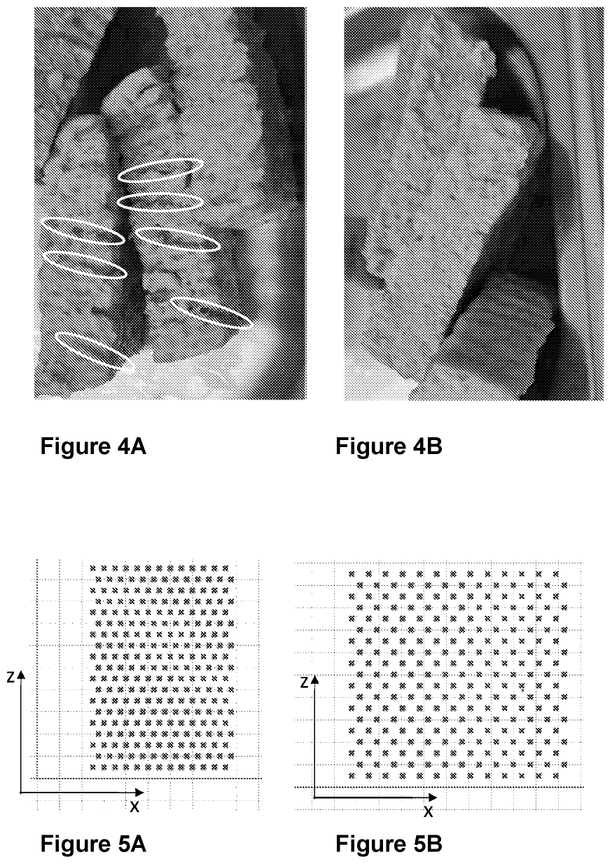

FIG. 4A and FIG. 4B are images of steak samples cut from a same whole-muscle meat analogue product, yet after the whole-muscle meat analogue product (before cutting the steak in half) was soaked with colored marinade. FIG. 4A and FIG. 4B demonstrate the importance of the elongated spaces for enabling liquid, such as the marinade, to penetrate into the inner spaces of the whole slab, as shown by the darker lines in FIG. 4A (some marked by white circles).

### Example 1B—Producing Meat Analogue using 3D Computer Model

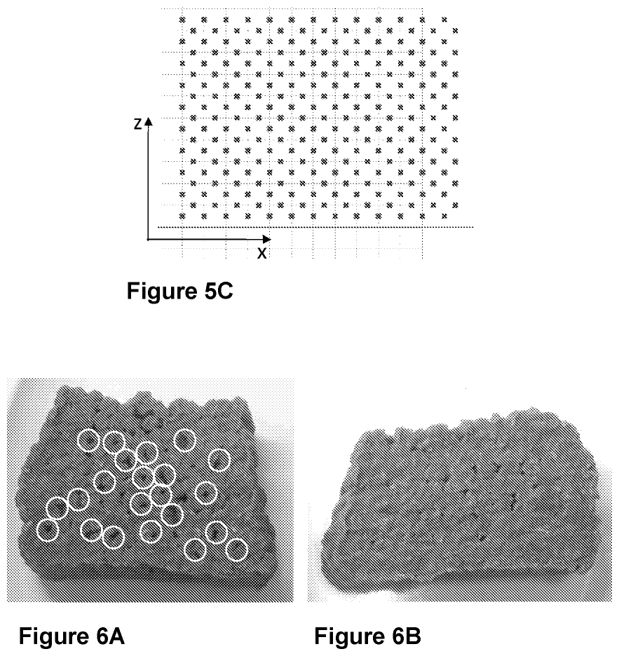

For the incorporation of aligned elongated fluid accommodating spaces within the protein mass to obtain the presently disclosed whole-muscle meat analogue product, elongated voids/channels are created during the printing of protein strands in the additive manufacturing (e.g. 3D printing) stages of the whole-muscle meat analogue product, by maintaining defined and controlled gaps between selected protein strands. The location and orientation of the elongated voids/channels is defined in accordance with a designed 3D computer-model implemented using a 3D printer. The product's packing density and orientation of the 3D-printed strands is tailored to produce elongated channels with specific orientation. In this connection, reference is made to FIGS. 5A-5C, illustrating three possible 3D models for printing, while allowing formation of channels (elongated spaces).

FIGS. 6A-6B are images of a steak sample produced to include elongated spaces (by 3D-printing) (FIG. 6A) and without the elongated spaces (FIG. 6B). See in this connection also FIG. 4A showing the elongated spaces.

FIG. 6A and FIG. 6B are clearly distinguished by the presence of well visualized voids, such as those marked by white circles, which are essentially lacking in FIG. 6B. FIG. 6B contains minor and less pronounced voids, all the more, elongated channels, that can be employed for holding liquid therein.

### Example 1C—Producing Elongated Spaces in Whole-Muscle Meat Analogue using Sacrificial Material

In accordance with this non-limiting example, a sacrificial dedicated material is incorporated between protein strands during additive manufacturing of the individual layers of the printed product. After completion of a defined volume of the whole-muscle meat analogue product, the sacrificial material is removed. For example, the sacrificial material is Agar-Agar water-based gel, and its removal is by a heat-treatment. The heat turns/fluidizes the viscous gel into an aqueous solution and enables its flowing out of the sample, leaving behind elongated voids.

### Example 2—Micro-CT Image Analysis for Determining Presence of Elongated Gas Filled Spaces

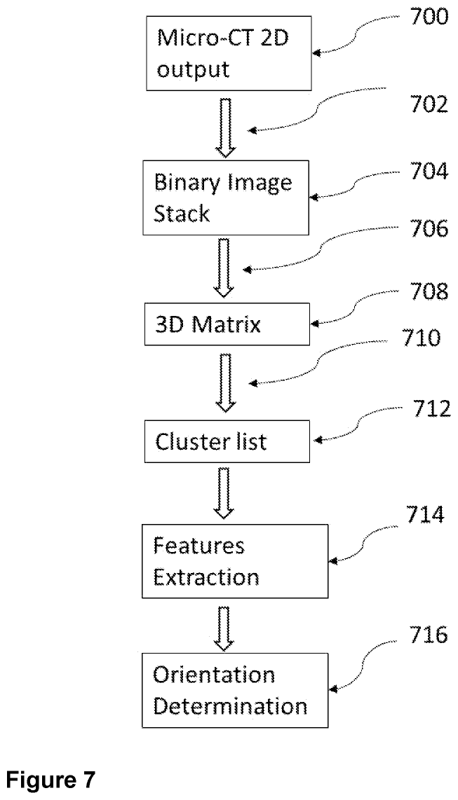

It is possible to identify the presence of elongated spaces within a finished 3D whole-muscle meat analogue product, without the need to sacrifice the product, by processing images acquired using imaging technologies such as micro-CT. The procedure is schematically illustrated in the Block Diagram of FIG. 7. Prior to the analysis procedure, micro-CT imaging is performed with steak sample from the whole-muscle meat analogue having dimensions of 2 cm*2 cm*steak thickness [XZ*YZ*XY] providing a micro-CT 2D output (700).

Specifically, as shown in FIG. 7, Analyzing the Micro-CT 2D output (700) includes applying a step of Thresholding (702) wherein a micro-CT data output image stack (BMP, JPEG, etc.) is transformed into binary images stack (704) through grayscale thresholding.

The Binary Images are Compiled (706) to form a 3D Matrix (708), with a voxel dimensions set according to the micro-CT pixel (x,y=42 microns) and slicing (50 microns) resolution.

In step 710, voxels comprising the 3D matrix are then negated and dilated (by one pixel), in order to prevent misrepresentation of the open space volume. The interconnected pixels are then combined to form a Cluster List (712) that represents each open space volume.

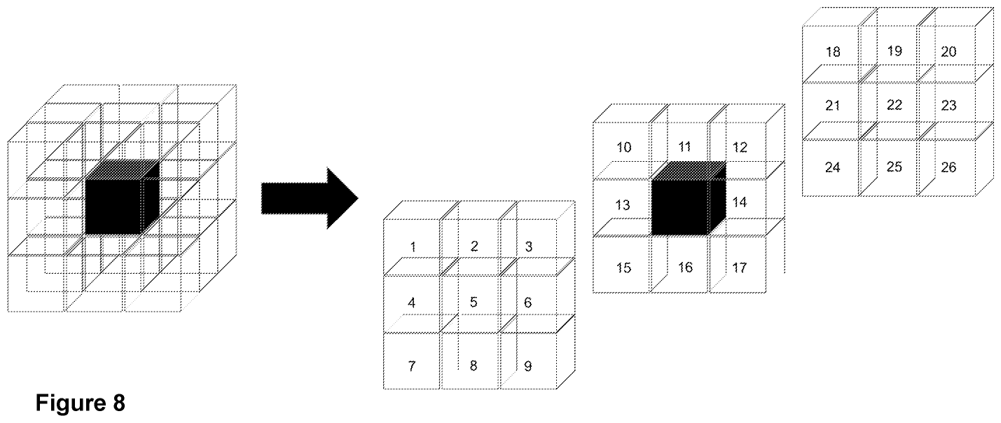

For this purpose, a cluster is the set of all voxels that are interconnected by at least one of their 26 nearest voxel neighbors, as schematically shown in FIG. 8 where the center voxel (shown as a black box) is surrounded by neighboring voxels 1-26. In this example, if the central voxel is a void that is associated with a certain cluster, voids in positions 1-26 will be associated with the same cluster.

For each cluster from the cluster list, features extraction takes place (714). The features may include length (defined as the span along the z direction), thickness (combined span along x and y dimensions), aspect-ratio (ratio of length and thickness).

Finally, in step 716, orientation of each cluster is determined, for instance by linearly fitting the centroids of voids in each layer, with respect to the vertical position of the layer). The orientation is presented as an angle in degrees with respect to the vertical axis.

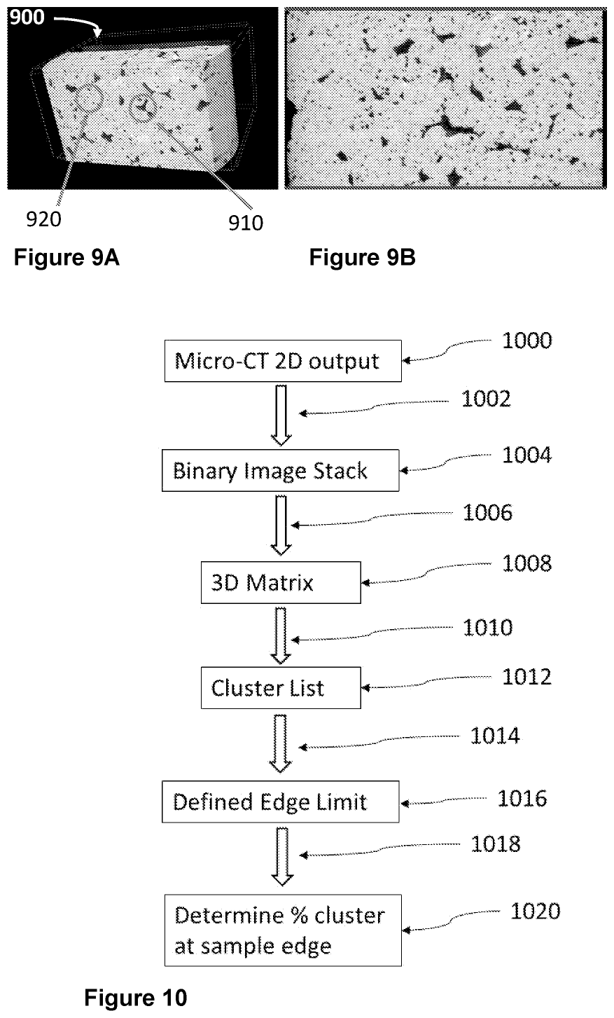

FIGS. 9A is a 3-D image of a sample of a whole-muscle meat analogue product (900) created from a stack of a micro-CT image slices, showing different size of voids (larger ones in 910 and smaller ones in 920). The analysis identifies voids that are elongated void/channels (910) and calculates their properties.

FIG. 9B is a slice out of the micro-CT image of FIG. 9A

### Example 3—Micro-CT Image Analysis for Determining Percentage of Elongated Spaces Exposed to the Outer Environment through the Edges of the Sample

The edge limit of the sample (also referred to herein as the external surface) was defined at a distance of 0.25 mm or less from either edge of the sample, when measured perpendicular to the vertical axis. In other words, the edge of the sample is defined as a “shell” of 0.25 mm thickness at the boundary of the sample, based on the 3D image. An elongated void that is calculated to reach the edge limit is classified as open to the environment around the sample.

Based on the clusters calculated the same way as shown in Example 2, for each cluster, it is determined whether any of its pixels are within the defined edge limit. Then, the fraction of elongated voids that reach the edges of the sample is calculated (FIG. 10).

Specifically, as shown in FIG. 10, Analyzing the Micro-CT 2D output which is received as an image stack (1000) includes applying a step of Thresholding (1002) wherein a micro-CT data output image stack (BMP, JPEG, etc.) is transformed into binary images stack (1004) through grayscale thresholding.

The Binary Images are then Compiled (1006) by constant grid compilation to form a 3D Matrix (1008), with a voxel dimensions set according to the micro-CT pixel (x,y=42 microns) and slicing (50 microns) resolution.

In step 1010, voxels comprising the 3D matrix are then negated and dilated (by one pixel), in order to prevent misrepresentation of the open space volume. The interconnected pixels are then combined to form a Cluster List (1012) that represents each open space volume.

In step 1014, the edge limit (1016) of the sample is defined as a distance of 0.25 mm or less from the sample's outer boundary. Thereafter, the clusters that include voxels that are within the defined edge limit of the sample are identified (1018) and the percentage of those clusters that include elongated voids that reach the edges of the sample out of the total number of elongated voids/channels is calculated (1020).

1-30 (canceled)

31. A whole-muscle meat analogue product, comprising:
a protein mass including protein strands; and
a plurality of fluid accommodating spaces within the protein mass, the plurality of fluid accommodating spaces having a length dimension and a cross-sectional dimension perpendicular to said length;
wherein at least a portion of said plurality of fluid accommodating spaces are elongated spaces extending between a first end and a second end;
wherein the length of the plurality of fluid accommodating elongated spaces is at least 2 mm and is at least twice larger than said cross sectional dimension;
wherein said protein strands are essentially aligned one with respect to another;
wherein at least 60% of the plurality of fluid accommodating elongated spaces are essentially parallel to the longitudinal direction of the protein strands; and
wherein said fluid in the plurality of fluid accommodating spaces is a gas.

32. The whole-muscle meat analogue product of claim 31, wherein at least one a portion of the first end and/or the second end of the elongated spaces are at least partially exposed at an external surface of the whole-muscle meat analogue product.

33. The whole-muscle meat analogue product of claim 31, wherein at least a portion of the plurality of fluid accommodating spaces are amorphous in shape.

34. The whole-muscle meat analogue product of claim 31, wherein each of the plurality of fluid accommodating elongated spaces is defined by an imaginary center and is spaced from a neighboring elongated space thereof with a distance between respective imaginary centers thereof of between 0.5 mm and 10 mm.

35. The whole-muscle meat analogue product of claim 31, wherein the plurality of fluid accommodating elongated spaces have essentially the same length and/or cross-sectional dimensions.

36. The whole-muscle meat analogue product of claim 31, wherein said plurality of fluid accommodating spaces have a volume that constitutes at least 5% out of a total volume of said product.

37. The whole-muscle meat analogue product of claim 31, being in a form of a whole slab or in a form of a steak, having a length and a width that define together a horizontal plane, and a cross sectional dimension being perpendicular to the horizontal plane and said plurality of elongated fluid accommodating spaces being essentially perpendicular to the horizontal plane.

38. The whole-muscle meat analogue product of claim 31, being suitable for marination with a marinade, whereby the marinade replaces said gas in at least a portion of the plurality of fluid accommodating spaces.

39. The whole-muscle meat analogue product of claim 31, wherein said protein mass comprises textured protein.

40. A method of producing a whole-muscle meat analogue product suitable for marination, the method comprising
disposing two or more layers of protein mass including protein strands one on top of another to form a multi-layer protein mass;
applying onto the multi-layer protein mass, controlled conditions that cause the arrangement of a plurality of fluid accommodating elongated spaces within the protein mass, the plurality of fluid accommodating elongated spaces being defined by a length and a cross sectional dimension and the conditions are selected such that
(i) at least a portion of the fluid accommodating elongated spaces extending between a first end and a second end;
(ii) the length of the fluid accommodating elongated spaces is at least 2 mm, and that is at least twice larger than the cross-sectional dimension; and
(iii) at least 60% of the plurality of fluid accommodating elongated spaces are essentially parallel to the longitudinal direction of said protein strands, with said protein strands being essentially aligned one with respect to another;
wherein said fluid in the plurality of fluid accommodating spaces is gas, and
wherein said plurality of fluid accommodating spaces are suitable for accommodating liquid.

41. The method of claim 40, wherein at least a portion of the first end and/or the second end of at least a portion of the plurality of fluid accommodating elongated spaces are exposed at an external surface of the whole-muscle meat analogue product.

42. The method of claim 40, wherein said conditions include any one or combination of:
disposing at least a portion of the protein strands with controlled distance therebetween;
disposing of the two or more layers of protein strands is by additive manufacturing techniques; or
disposing a sacrificial material in a form of intermediate strands between at least a portion of the protein strands and once said multi-layer protein mass is formed, removing or causing removal of said sacrificial material whereby said plurality of fluid accommodating elongated spaces are formed.

43. The method of claim 40, wherein said conditions include applying mechanical forces onto said multi-layer protein mass that result in the formation of said plurality of fluid accommodating elongated spaces.

44. The method of claim 43, wherein said mechanical forces include puncturing said protein mass.

45. The method of claim 40, wherein location and dimensions of said plurality of fluid accommodating elongated spaces are dictated by a pre-designed 3D model of said meat analogue.

46. The method of claim 42, further comprising compressing said multi-layer protein mass against the intermediate strands.

47. The method of claim 40, further comprising thermal treating of the multi-layer protein mass.

48. The method of claim 40, wherein said liquid is a marinade.

49. The method of claim 40, wherein said plurality of fluid accommodating elongated spaces are suitable for accommodating liquid once at least a portion of the whole muscle meat analogue product is immersed in said liquid.

50. A method of producing a marinated whole-muscle meat analogue, the method comprising:
immersing at least a portion of the whole-muscle meat analogue product of claim 31 in a marinade.
